(19) United States
(12) Patent Application Publication
(10) Pub. No.: US 2007/0151960 A1
(43) Pub. Date: Jul. 5, 2007

(54) Counterboring method with carbon dioxide gas laser

(75) Inventor: Yoji Asahi, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/637,813

(22) Filed: Dec. 13, 2006

(30) Foreign Application Priority Data
Dec. 21, 2005 (JP) P.2005-368198

(51) Int. Cl. B23K 26/38

(52) U.S. Cl. 219/121.71; 264/400

(57) ABSTRACT

When a counterboring method where a laser beam of a carbon dioxide gas laser is irradiated on a resin layer 34 that covers a pad formed on a surface of a first resin layer 30 and electrically connected to a conductor pattern 32 to partially remove the resin layer 34 to expose a pad surface is applied, in order to heighten the durability to the laser beam of the carbon dioxide gas laser of the resin layer 30 more than that of the resin layer 34, a compounding ratio of the filler in the resin layer 30 is increased more than that in the resin layer 34 and energy of the laser beam of the carbon dioxide gas laser irradiated on the resin layer 34 is controlled so as not to apply the laser processing to the resin layer 30.

### BACKGROUND OF THE INVENTION

The invention relates to a counterboring method with a carbon dioxide gas laser, in more detail, a counterboring method where a laser beam of a carbon dioxide laser is irradiated on a second resin layer that covers a pad electrically connected to a conductor pattern formed on a surface of a first resin layer to partially remove the second resin layer to exposed a pad surface.

In a patent literature 1 shown below, as shown in FIG. 4, a producing method where, on a solder resist layer 120 stacked on one surface side of a resin layer 12 that constitutes a wiring board 10, an annular opening 14 is formed, and, to pads 16, 16 . . . of a conductor pattern exposed on a bottom surface of the annular opening 14, a semiconductor element 18 is flip-chip mounted to produce a semiconductor device is proposed.

In order to form such an annular opening 14 on a solder resist layer 120 stacked on one surface side of a resin layer 12, so far, a counterboring method shown in FIGS. 5A to 5C has been adopted. In FIGS. 5A to 5C, [I] shows vertical sectional views in a direction in parallel with a conductor pattern formed on one surface side of a resin layer 12 and [II] shows horizontal sectional views in a direction perpendicular to the conductor pattern.

In the beginning, as shown in FIG. 5A, after conductor patterns 20, 20 . . . are formed on one surface side of a resin layer 12, a solder resist is coated so as to cover the conductor patterns 20, 20 to form a solder resist layer 120 [FIG. 5B]. In the solder resist, a photosensitive material is compounded.

In the next place, when the solder resist layer 120 where the photosensitive material is compounded is subjected to photosensitization and development processes, as shown in FIG. 5C, an annular opening 14 can be formed in the solder resist layer 120 and, on a bottom surface of the annular opening 14, a pad surface formed on each of the conductor patterns 20, 20 . . . is exposed.

[Patent Literature 1] JP-A-11-186322

According to a counterboring method shown in FIGS. 5A to 5C, an annular opening 14 can be readily formed in a solder resist layer 120.

However, a solder resist that forms the solder resist layer 120 is compounded with a photosensitive material. In general, the electric characteristics of the solder resist layer 120 in which such photosensitive material is compounded is inferior to that of a resin layer 12 in which the photosensitive material is not compounded.

Accordingly, it is demanded to form a solder resist layer 120 with a resin in which a photosensitive material is not compounded.

In order to respond to such a demand, the present inventor investigated whether a counterboring method with a laser shown in FIGS. 6A to 6C can be applied to form an annular opening or not.

In the counterboring method shown in FIGS. 6A to 6C, in the beginning, as shown in FIG. 6A, after pads 102, 102 . . . connected to a conductor pattern are formed according to a known method on one surface side of a resin layer 100, with a resin same as that that forms the resin layer 100, a resin layer 100′ that covers the conductor pattern and the pads 102, 102 . . . is formed [FIG. 6B].

In the next place, a laser beam of a carbon dioxide gas laser that can laser process a resin but cannot laser process metal is irradiated on a top surface of the resin layer 100′ to form in the resin layer 100′ an opening where pad surfaces of the pads 102, 102 . . . are exposed on a bottom surface.

However, on the bottom surface of the formed opening, as shown in FIG. 6C, biting-in portions 104 are formed on the respective sides of the pads 102, 102, and thereby an exposed surface of the resin layer 100 that forms a bottom surface of the opening is formed into a irregular surface.

When such an irregular surface is formed on an exposed surface of the resin layer 100, when a semiconductor element 18 is flip-chip mounted on the pads 102, 102, in some cases, a solder on the pad 102 flows in an unnecessary portion and an underfill can be filled with difficulty between the semiconductor element 18 and the resin layer 100 owing to presence of air bubbles or the like.

Thus, except that an exposed surface of the resin layer 100 that forms a bottom surface of the opening opened in the resin layer 100′ is formed in an irregular surface, conductor patterns connected to each of the pads 102, 102 . . . are covered with a resin of the same composition as that of a resin that forms the resin layer 100. Accordingly, in comparison with a case where a solder resist in which a photosensitive material is compounded is used to cover, the electric characteristics thereof can be improved.

### SUMMARY OF THE INVENTION

In this connection, an object of the invention is to provide a counterboring method with a carbon dioxide gas laser, which, when a laser beam of a carbon dioxide gas laser is irradiated on a second resin layer that covers a pad electrically connected to a conductor pattern formed on a surface of a first resin layer to partially remove the second resin layer to expose a pad surface, can form as flat as possible an exposed surface of the first resin layer that forms a bottom surface of the formed opening.

The inventor, in order to overcome the problems, in the beginning, studied a reason why an exposed surface of a resin layer 100 that forms a bottom surface of an opening opened in a resin layer 100′ is formed in an irregular surface as shown in FIG. 6C and found that the reason is in that, as shown in FIG. 7, a beam diameter of a laser beam 106 of a carbon dioxide gas laser that applies a counterboring method to the resin layer 100′ cannot be focused in a diameter smaller than a pad width of the pad 102.

That is, in the case of a laser beam 106 having a diameter larger than the pad width of the pad 102 being irradiated on the resin layer 100′ to expose a pad surface of the pad 102, when the laser beam 106 can be instantly stopped irradiating, the laser processing owing to irradiation of the laser beam can be stopped.

However, in order to determine the timing for stopping the irradiation of such a laser beam 106, experienced skill is necessary. Accordingly, in many cases, after the pad surface of the pad 102 is exposed, subsequently, the laser beam 106 is irradiated. In that case, the laser beam 106 overflowed from the pad surface is irradiated on an exposed surface of the resin layer 100 to apply a laser processing to the exposed surface of the resin layer 100 and thereby an exposed surface of the resin layer 100 that forms a bottom surface of the opening opened in the resin layer 100′ is formed in an irregular surface.

The inventor considered that, in the case of a laser beam 106 having a diameter larger than a pad width of a pad 102 being irradiated on a resin layer 100′ to expose a pad surface of the pad 102 followed by subsequently irradiating the laser beam 106, when an exposed surface of the resin layer 100 forms a resin layer difficult to be processed with a laser beam, an exposed surface of the resin layer 100 that is exposed on a bottom surface of an opening opened in the resin layer 100′ could be flattened and studied this, and thereby the invention has been achieved.

That is, there is provided a counterboring method with a carbon dioxide laser including the steps of:

forming a first resin layer from a resin that has the durability to a laser beam of the carbon dioxide gas laser more than a resin that forms a second resin layer;

irradiating the laser beam of the carbon dioxide laser on the second resin layer that covers a pad electrically connected to a conductor pattern formed on a surface of the first resin layer to partially remove the second resin layer to expose a pad surface; and

controlling energy of the laser beam of the carbon dioxide gas laser that irradiates the second resin layer so as not to apply the laser process to the first resin layer.

In an invention such as this, when, as a resin that forms the first resin layer, a resin where filler that has the durability to the laser beam of the carbon dioxide gas laser is compounded at higher compounding ratio than that of the filler compounded in a resin that forms the second resin is used, the first resin layer that has the durability to the laser beam of the carbon dioxide gas laser can be readily formed.

The compounding ratio of the filler in the resin that forms the second resin layer is preferably set in the range of 10 to 25 wt % in view of the characteristics as an insulating layer of the second resin layer and the laser processability with the carbon dioxide gas laser.

When the compounding ratio of the filler in the resin that forms the first resin layer in contact with the second resin layer is set in the range of 1.5 to 3 times the compounding ratio of the filler in the resin that forms the second resin layer, even if the second resin layer is removed with the carbon dioxide gas laser, an exposed surface of the first resin layer can be damaged as small as possible with the carbon dioxide gas laser.

As the filler compounded in the resins that constitute the first resin layer and the second resin layer, silica based filler can be preferably used.

Furthermore, energy of the laser beam of the carbon dioxide gas laser that irradiates the second resin layer can be readily controlled by placing the second resin layer at a defocus position deviated from a focus of the laser beam.

Still furthermore, in order to expose only a surface of a predetermined portion to be counterbored of the second resin layer, after other surface of the second resin layer is covered with a mask made of a material that has the durability to the laser beam of the carbon dioxide gas laser, the laser beam of the carbon dioxide gas laser is irradiated, thereby, the predetermined portion of the second resin layer can be readily counterbored with the carbon dioxide gas laser.

As the mask, a mask made of a metal film can be preferably used.

Besides, the compounding ratio of the filler in the resin that forms the first resin layer may be set in the range of more than or equal to 1.5 times the compounding ratio of the filler in the resin that forms the second resin layer.

According to the invention, the first resin layer is formed of a resin that has the durability to the laser beam of the carbon dioxide gas laser more than a resin that forms the second resin layer stacked on the first resin layer, and energy of the laser beam of the carbon dioxide gas laser that irradiates the second resin layer is controlled so as not to apply the laser process to the first resin layer.

Accordingly, even when the laser beam of the carbon dioxide gas laser is irradiated on a predetermined position of the second resin layer to counterbore and expose the first resin layer and thereafter the laser beam is irradiated on an exposed surface of the first resin layer, the exposed surface of the first resin layer can be damaged as small as possible by the irradiation of the laser beam.

As a result, when a second resin layer formed with a resin in which a photosensitive material is not compounded is stacked on a first resin layer and a predetermined portion of the second resin layer is counterbored with the carbon dioxide gas laser, an opening of which bottom surface is formed of a flat surface of the first resin layer can be formed in the second resin layer.

Thus, since the second resin layer can be formed from a resin in which a photosensitive material is not compounded and the second resin layer can be formed of a resin excellent in the electrical characteristics, a wiring board excellent in the electrical characteristics can be obtained.

### BRIEF DESCRIPTION OF THE DRAWINGS

FIGS. 1A to 1E are process charts explaining an example of a counterboring method with a carbon dioxide gas laser according to the invention.

FIGS. 2A and 2B are explanatory diagrams for explaining a control method of energy of a laser beam of a carbon dioxide gas laser that can be adopted in the counterboring method shown in FIGS. 1A to 1E.

FIG. 3 is a partially enlarged sectional view for explaining an extent of damage of an exposed surface of a resin layer exposed owing to a counterboring method with a carbon dioxide gas laser.

FIG. 4 is an explanatory diagram for explaining an example of a producing method of a semiconductor device.

FIGS. 5A to 5C are process charts for explaining an existing producing method of a substrate shown in FIG. 4.

FIGS. 6A to 6C are explanatory diagrams for explaining a situation where a counterboring method is tried with a carbon dioxide gas laser.

FIG. 7 is an explanatory diagram for explaining an irradiation situation of a laser beam of a carbon dioxide gas laser in the counterboring method shown in FIGS. 6A to 6C.

### DETAILED DESCRIPTION OF THE PREFERRED EMBODIMENTS

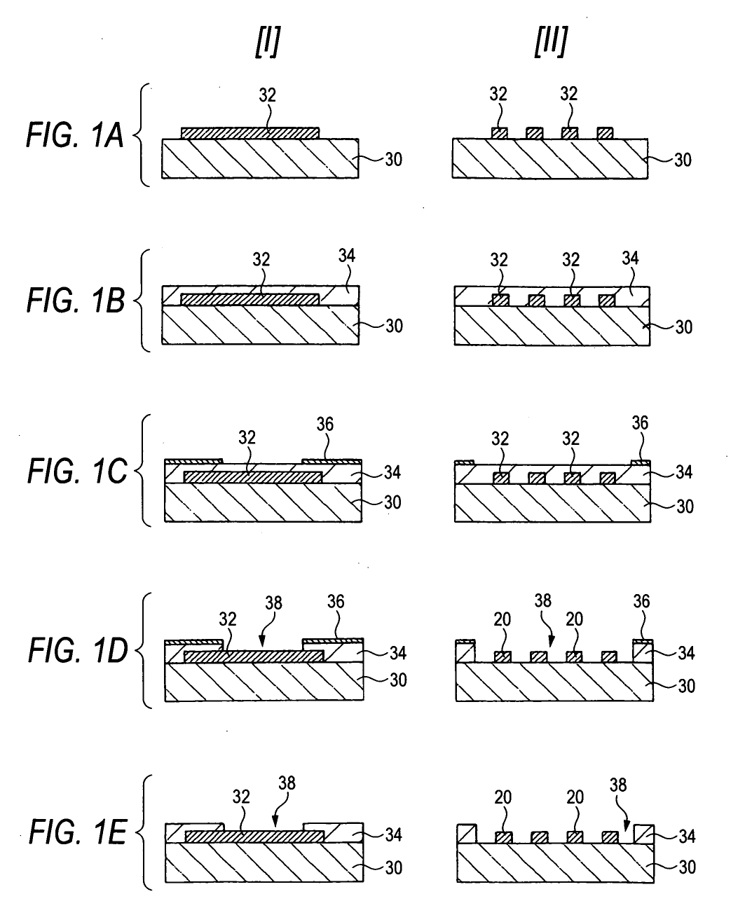

An example of a counterboring method with a carbon dioxide gas laser of the invention is shown in FIGS. 1A to 1E. In FIGS. 1A to 1E, [I] shows vertical sectional views in a direction parallel with a conductor pattern formed on one surface side of a first resin layer, and [II] shows horizontal sectional views in a direction perpendicular to the conductor pattern.

In the beginning, as shown in FIG. 1A, after conductor patterns 32, 32 . . . are formed on one surface side of a resin layer 30 as a first resin layer formed of an epoxy resin in which the filler having the durability to a laser beam of a carbon dioxide gas laser is compounded, on one surface side of the resin layer 30, a resin layer 34 as a second resin layer made of an epoxy resin that covers the conductor patterns 32, 32 . . . is formed [FIG. 1B]. The resin layer 30 is formed of an epoxy resin in which the filler that has the durability to a laser beam of a carbon dioxide gas laser is added and a compounding ratio of the filler in the resin layer 30 is set higher than the compounding ratio of the filler in the resin layer 34.

The compounding ratio of the filler in the resin layer 34 is preferably set in the range of 10 to 20 wt % from viewpoints of the laser processability with the carbon dioxide gas laser and the characteristics of an insulating layer. Furthermore, when the compounding ratio of the filler in the resin layer 30 is set in the range of substantially 1.5 to 3 times, preferably substantially two times the compounding ratio of the filler in the resin layer 34, as described below, when the laser processing of the resin layer 34 with the carbon dioxide gas laser comes to completion, an exposed surface of the resin layer 30 can be damaged as less as possible owing to the laser processing.

As such filler, the filler made of SiO₂ and having an average particle diameter of 1.0 μm (maximum diameter: 5 μm) can be preferably used.

In the next place, after a copper film 36 is formed on a surface of the resin layer 34 by means of the electroless copper plating, the copper film 36 is etched and counterbored with the carbon dioxide gas laser to expose a surface of the resin layer 34 [FIG. 1C].

On the exposed surface of the resin layer 34, a counterboring method where a laser beam of the carbon dioxide gas laser is irradiated to partially remove the resin layer 34 to expose a pad surface formed on a conductor pattern 32 is applied. At this time, the resin layer 30, being more compounded with the filler than the resin layer 34, has the durability to the laser beam of the carbon dioxide gas laser. Accordingly, when energy of the laser beam of the carbon dioxide gas laser that irradiates the resin layer 34 is controlled, the laser processing can be controlled so as to apply only to the resin layer 34 but substantially not to the resin layer 30.

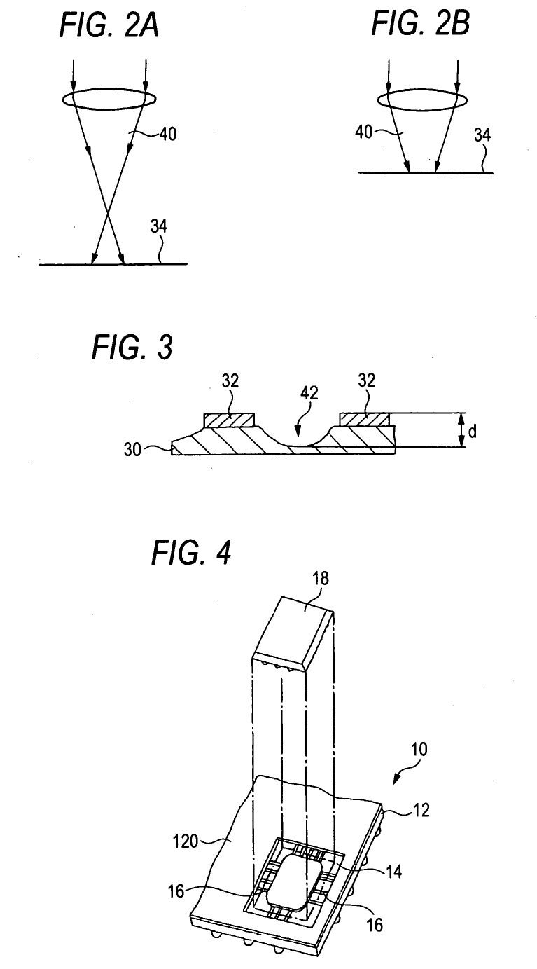

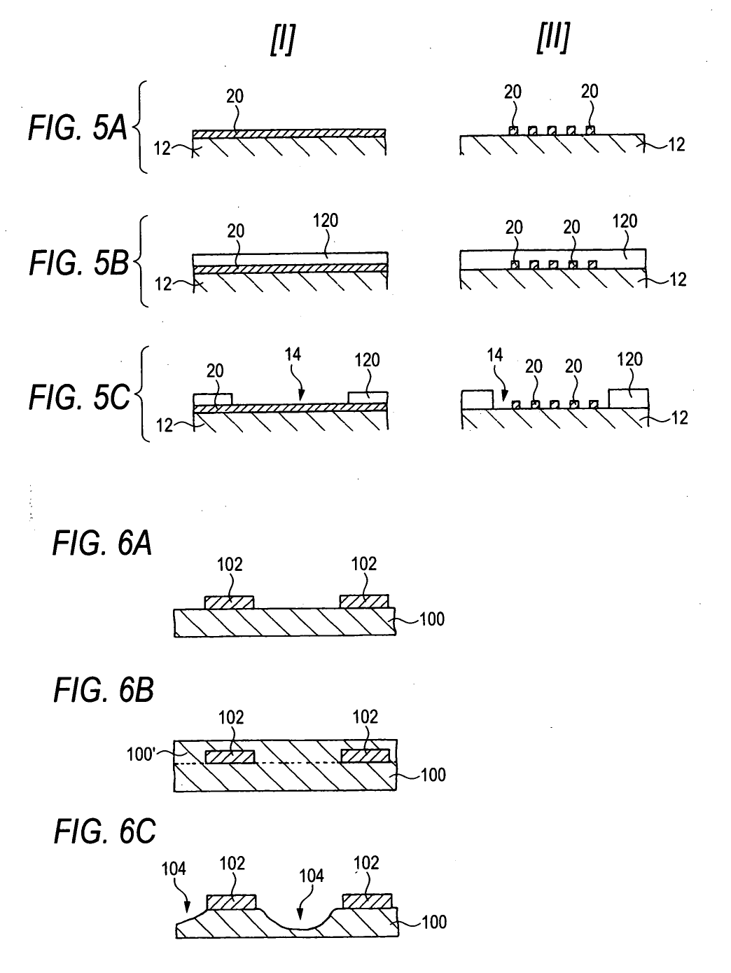

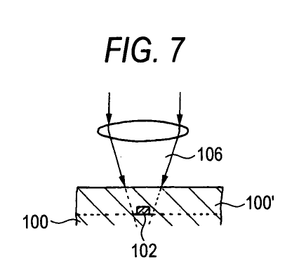

Such a control of energy of the laser beam of the carbon dioxide gas laser can be applied by controlling the laser power as well. However, as shown in FIGS. 2A and 2B, when the exposed surface of the resin layer 34 is position controlled so as to be a defocused position deviated from a focus of a laser beam 40, the energy control of the laser beam can be readily carried out. The defocused position, as shown in FIG. 2A, may be on a lower side than the focus of the laser beam or, as shown in FIG. 2B, may be on an upper side than the focus of the laser beam 40.

A defocusing amount is controlled with the laser power, the resin material and a counterboring area.

Thus, when an exposed surface of the resin layer 34 is placed at a defocused position deviated from a focus of the laser beam 40, even when an irradiation area of the resin layer 34 of the laser beam 40 is expanded larger than the exposed surface of the resin layer 34, since a portion where the counterboring method is not applied of the resin layer 34 is covered with the copper film 36, only the exposed surface of the resin layer 34 can be laser processed.

Furthermore, when energy of the laser beam of the carbon dioxide gas laser that irradiates the resin layer 34 is controlled so as to apply the laser processing only to the resin layer 34 and substantially not to the resin layer 30, even when, immediately after the laser processing of the resin layer 30 comes to completion to expose a surface of the resin layer 30, without stopping the irradiation of the carbon dioxide gas laser, the carbon dioxide gas laser is a little continued irradiating, since the exposed surface of the resin layer 30 is hardly processed, the exposed surface of the resin layer 30 can be kept in a flat surface. Accordingly, the counterboring method of the resin layer can be readily carried out with the carbon dioxide gas laser.

Thereafter, the copper film 36 is etched and removed, and, as needs arise, a pad surface of an exposed pad surface is desmeared [FIG. 1E].

Here, after conductor patterns 32, 32 . . . are formed on one side of the resin layer 30 made of an epoxy resin in which 38 wt % of the filler made of SiO₂ having an average particle diameter of 1.0 μm (maximum diameter: 5 μm) is compounded, as shown in Table 1 shown below, the compounding ratio of the filler in the epoxy resin and a thickness are varied to prepare resin layers 34. In the resin layer 34, a laser beam of a carbon dioxide gas laser controlled in energy as shown in Table 1 below is irradiated and depths d of biting portions 42 shown in FIG. 3 and formed on both sides of the conductor pattern 32 are measured and shown together in Table 1.

The energy of the laser beam of the carbon dioxide gas laser is controlled, with a defocusing amount thereof maintained constant at 20 μm from an exposure surface of the resin layer 30, by controlling laser power of the carbon dioxide gas laser. Values thereof are shown in Table 1.

TABLE 1

| | Resin | | | | |
|---|---|---|---|---|---|
| | Layer 30 | Resin Layer 34 | | Depth d | Energy |
| | Compound- | Compound- | Thickness | of Biting | of |
| | ing Amount | ing Amount | on Conductor | Portion | Laser |
| No. | of Filler | of Filler | Pattern 32 | 42 | Beam |
| 1 | 38 wt % | 38 wt % | 20 μm | 25 μm | 11.6 mJ |
| 2 | 38 | 38 | 10 | 35 | 11.6 |
| 3 | 38 | 25 | 20 | 25 | 8.1 |
| 4 | 38 | 25 | 10 | 10 | 8.1 |
| 5 | 38 | 18 | 20 | 10 | 5.8 |
| 6 | 38 | 18 | 10 | 5 | 5.8 |

Note)
Nos. 1 and 2 are comparative examples.

As obvious from Table 1, in a level (comparative examples 1 and 2) of Nos. 1 and 2 where the compounding ratio of the filler is same in the resin layer 30 and the resin layer 34, in comparison with levels (examples) where a compounding ratio of the filler of the resin layer 34 is set lower than that of the resin layer 30, the depth d of the biting portion 42 is deep.

Furthermore, among levels where the compounding ratio of the filler of the resin layer 34 is set lower than that of the resin layer 30, levels of Nos. 5 and 6 where the compounding ratio is set at substantially one half that of the filler of the resin layer 30 can make the depth d of the biting portion 42 shallowest.

In an example of a counterboring method with a carbon dioxide gas laser according to the invention and shown in FIGS. 1A to 1E, both the resin layer 30 and the resin layer 34 can be formed from an epoxy resin. Even when the counterboring method is applied to the resin layer 34 with the carbon dioxide gas laser, an exposed surface of the exposed resin layer 30 can be damaged as less as possible with the carbon dioxide gas laser.

Furthermore, the resin layer 34 that covers the conductor patterns 32, 32 . . . and so on formed on one surface side of the resin layer 30 can be formed with an epoxy resin where a photosensitive material is not compounded and the electric characteristics thereof can be made substantially same as that of the resin layer 30.

Accordingly, when, as a wiring board 10 shown in FIG. 4, a wiring board obtained by means of the counterboring method with a carbon dioxide gas laser and shown in FIGS. 1A to 1E is used, a semiconductor device excellent in the electric characteristics can be provided.

Besides, a YAG laser, a UV-YAG laser of the third higher harmonic wave and UV wave Excimer laser may be used for a carbon dioxide gas laser.

What is claimed is:

1. A counterboring method with a carbon dioxide laser, comprising the steps of:
forming a first resin layer from a resin that has the durability to a laser beam of the carbon dioxide gas laser more than a resin that forms a second resin layer;
irradiating the laser beam of the carbon dioxide laser on the second resin layer that covers a pad electrically connected to a conductor pattern formed on a surface of the first resin layer to partially remove the second resin layer to expose a pad surface; and
controlling energy of the laser beam of the carbon dioxide gas laser that irradiates the second resin layer so as not to apply the laser process to the first resin layer.

2. The counterboring method according to claim 1, wherein
as a resin that forms the first resin layer, a resin where filler that has the durability to the laser beam of the carbon dioxide gas laser is compounded at a higher compounding ratio than that of the filler compounded in a resin that forms the second resin layer is used.

3. The counterboring method according to claim 2, wherein
the compounding ratio of the filler in the resin that forms the second resin layer is set in the range of 10 to 25 wt %.

4. The counterboring method according to claim 2, wherein
the compounding ratio of the filler in the resin that forms the first resin layer is set in the range of 1.5 to 3 times the compounding ratio of the filler in the resin that forms the second resin layer.

5. The counterboring method according to claim 2, wherein
as the filler, silica based filler is used.

6. The counterboring method according to claim 1, wherein
energy of the laser beam of the carbon dioxide gas laser that irradiates the second resin layer is controlled by placing the second resin layer at a defocus position deviated from a focus of the laser beam.

7. The counterboring method according to claim 1, wherein
in order to expose only a surface of a predetermined portion to be counterbored of the second resin layer, after other surface of the second resin layer is covered with a mask made of a material that has the durability to the laser beam of the carbon dioxide gas laser, the laser beam of the carbon dioxide gas laser is irradiated.

8. The counterboring method according to claim 7, wherein
as the mask, a mask made of a metal film is formed.

9. The counterboring method according to claim 2, wherein
the compounding ratio of the filler in the resin that forms the first resin layer is set in the range of more than or equal to 1.5 times the compounding ratio of the filler in the resin that forms the second resin layer.
